(19) United States
(12) Patent Application Publication
(10) Pub. No.: US 2026/0329450 A1
(43) Pub. Date: Oct. 22, 2026

(54) REMAINING LIFETIME MONITORING AND INDICATION FOR MEMORY SYSTEMS

(71) Applicant: Micron Technology, Inc., Boise, ID (US)

(72) Inventors: John E. Maroney, Irvine, CA (US); Nicholas T. Heath, Pittsboro, NC (US); Pedro Cordon, Irvine, CA (US); Matthew J. Rozek, Folsom, CA (US); Henry H. Torabi, Irvine, CA (US)

(21) Appl. No.: 19/181,066

(22) Filed: Apr. 16, 2025

(51) Int. Cl. G06F 3/06; G01K 3/14

(52) U.S. Cl. CPC G06F 3/0616; G01K 3/14; G06F 3/0653; G06F 3/0673

(57) ABSTRACT

Methods, systems, and devices for remaining lifetime monitoring and indication for memory systems are described. The described techniques provide for a memory system to estimate a remaining portion of the expected lifetime of the memory system during operation of the memory system according to various functions. The memory system may execute one or more access operations during a first duration of operation and may measure one or more temperatures during the first duration. The memory system may calculate temperature stress values according to the measured temperatures and acceleration factors associated with the measured temperatures. The memory system may sum the temperature stress values. In some examples, the memory system may divide the summed temperature stress values by an allowable stress budget associated with the mission profile for the memory system, such that the memory system may obtain a percentage of expected remaining lifetime after calculating each temperature stress sample.

### TECHNICAL FIELD

The following relates to one or more systems for memory, including remaining lifetime monitoring and indication for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports remaining lifetime monitoring and indication for memory systems in accordance with examples as disclosed herein.

FIG. 2 shows an example of a process that supports remaining lifetime monitoring and indication for memory systems in accordance with examples as disclosed herein.

FIG. 3 shows a reliability graph that supports remaining lifetime monitoring and indication for memory systems in accordance with examples as disclosed herein.

FIG. 4 shows a block diagram of a memory system that supports remaining lifetime monitoring and indication for memory systems in accordance with examples as disclosed herein.

FIG. 5 shows a flowchart illustrating a method or methods that support remaining lifetime monitoring and indication for memory systems in accordance with examples as disclosed herein.

### DETAILED DESCRIPTION

Some memory systems may be implemented in or otherwise operated in accordance with various systems and devices. For example, a memory system may be incorporated in a device, such as a device in a vehicle, and may perform memory operations associated with operation of the vehicle. For example, the memory system may be communicatively coupled with a host system of the vehicle and may perform access operations in accordance with execution of one or more applications based on commands issued by the host system. Such a memory system may experience performance degradation over time, however, for example, due to wear associated with performing a relatively high quantity of access operations during an operable life of the memory system. In some examples, an estimated operable life of the memory system may be determined based on a use case for the memory system or a type of system the memory system is implemented in during the operable life of the memory system. For example, different customer products or implementations may be associated with different estimated operable lifetimes.

The estimated operable life of the memory system may be referred to as a mission profile, where the mission profile may predict estimated durations over which the memory system will operate at various conditions, such as temperature values. For example, the mission profile may estimate that a majority of operation of the memory system will be at a first temperature, and other, shorter, durations of the operation of the memory system may be performed at other various temperatures. Performance degradation of the memory system may be correlated with operating temperature, such that operating at a relatively high temperature may result in relatively higher performance degradation of the memory system. Accordingly, the mission profile may be used to estimate an expected lifetime of the memory system (e.g., an expected duration for which the memory system with reliably perform). In some examples, however, the mission profile may not be able to accurately predict operation patterns for multiple different memory systems. For example, during implementation of the memory system, the memory system may dwell at temperatures for different durations than those predicted in the mission profile (e.g., based on various unexpected or otherwise unpredictable parameters or elements within the environment around the memory system). However, the memory system may be unaware of how such variations in actual implementation relative to the mission profile may affect the remaining operable lifetime of the memory system, which may result in unexpected failure of the memory system or otherwise may introduce ambiguity as to the remaining lifetime of the memory system.

Techniques described herein provide for a memory system to estimate a remaining portion of the expected lifetime of the memory system during operation of the memory system according to various functions. For example, the memory system may execute one or more access operations during a first duration of operation (e.g., an active drive duration or a trip duration) and may measure one or more temperatures during the first duration. In some examples, the one or more temperatures may correspond to composite temperature values (e.g., associated with multiple component types in the memory system) or may correspond to temperature values of components having a similar component type (e.g., volatile memory arrays, non-volatile memory arrays, controllers). The memory system may determine (e.g., calculate) temperature stress values according to the measured temperatures and according to one or more acceleration factors associated with the measured temperatures (e.g., scalars associated with a magnitude of performance degradation for various temperatures). The memory system may determine (e.g., sum) the temperature stress values obtained over time (e.g., over some operation duration). In some examples, the memory system may determine (e.g., divide) the summed temperature stress values by an allowable stress budget associated with the mission profile for the memory system (e.g., a value representing the expected life of the memory system), such that the memory system may determine (e.g., obtain) a percentage of expected remaining lifetime after determining (e.g., calculating) each temperature stress sample. The memory system may perform the determinations (e.g., calculations) periodically, or at one or more defined time intervals, or in response to a request (among other examples), such that the memory system may track how much of an expected lifetime the memory system is using during operation.

In some cases, the memory system may report a lifetime usage indication (e.g., indicating a remaining portion of the expected lifetime of the memory system) if the memory system determines (e.g., calculates) a percentage of expected remaining lifetime that satisfies a threshold value, which may be configured according to testing operations performed during manufacture of the memory system. Additionally, or alternatively, the memory system may report the lifetime usage indication in response to one or more requests from the host system. By determining (e.g., calculating) and reporting the expected remaining lifetime of the memory system, the memory system may mitigate a likelihood of unexpected failure and support the host system adjusting operational parameters for the memory system when the memory system is relatively close to failure, among other advantages.

In addition to applicability in memory systems as described herein, techniques for remaining lifetime monitoring and indication may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving operable life estimation, which may extend the life of electronic devices and thereby reducing electronic waste, among other benefits.

Features of the disclosure are illustrated and described in the context of systems, devices, and circuits. Features of the disclosure are further illustrated and described in the context of a process and flowcharts.

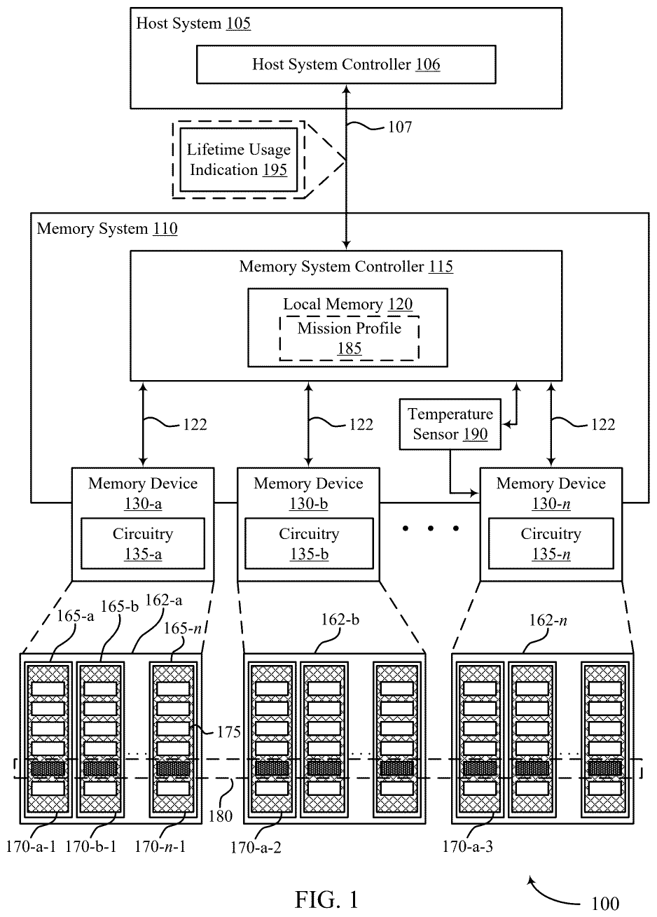

FIG. 1 shows an example of a system 100 that supports remaining lifetime monitoring and indication for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0” of a first plane of die 162-a, block 170-a-2 may be “block 0” of a first plane of die 162-b, block 170-a-3 may be “block 0” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some systems 100, a memory system 110 may be incorporated in a device, such as a vehicle, and may perform operations in accordance with commands from a host system 105 of the vehicle (e.g., an autonomous vehicle, a “robotaxi”, or the like). For example, the memory system 110 may perform access operations to access data at one or more memory devices 130 based on receiving commands from the host system 105. In some cases, the memory system 110 may experience performance degradation over time, for example due to wear associated with performing a relatively high quantity of access operations during an operable life of the memory system 110. In some examples, an operable life of the memory system 110 may be estimated (e.g., during manufacture of the memory system 110, based on testing operations), where the estimation may be based on a type of device or vehicle the memory system 110 will be incorporated in (e.g., different costumer products or implementations may be associated with different estimated operable lifetimes).

The estimated operable life of the memory system 110 may be referred to as a mission profile 185, and may be stored to the memory system 110 (e.g., during manufacturing). For example, the memory system 110 may store the mission profile 185 in the local memory 120. Alternatively, the memory system 110 may store the mission profile 185 in other memory, such as within a memory device 130, a non-volatile array of memory cells, a volatile array of memory cells, or the like. The mission profile 185 may predict durations that the memory system 110 is expected to operate in at various temperature values. As such, the mission profile 185 may be indicative of an expected lifetime of the memory system 110 before the memory system 110 degrades or is otherwise inoperable or unreliable. For example, performance degradation may be correlated with operating temperature, such that operating at a relatively high temperature may result in relatively higher performance degradation at the memory system 110. In some cases, during implementation of the memory system 110, the memory system 110 may dwell at some temperature values for different durations than those predicted by the mission profile 185. However, the memory system 110 may be unaware of how such variations in implementation relative to the mission profile affects the remaining operable lifetime of the memory system 110, which may result in unexpected failure of the memory system 110 or otherwise may introduce ambiguity as to the remaining lifetime of the memory system 110.

Techniques described herein provide for a memory system 110 to estimate a remaining portion of the expected lifetime of the memory system 110 according to various functions. In some cases, the memory system 110 may execute access operations and may measure one or more temperatures while operating (e.g., during standard operations of a vehicle including the memory system 110). For example, the memory system 110 may use one or more temperature sensors 190 to measure one or more components of the memory system 110 and obtain the one or more temperatures. In some cases, the memory system 110 may include a respective temperature sensor 190 for each component of the memory system 110, a respective temperature sensor 190 for each type of component of the memory system 110, a single temperature sensor 190 configured to measure each component of the memory system 110, or any other suitable sensor configuration to enable the memory system 110 to obtain temperature values for one or more components. The components described herein may refer to the memory devices 130, the memory system controller 115, one or more other controllers, one or more arrays of volatile memory cells, one or more arrays of non-volatile memory cells, or any combination thereof.

In some examples, the one or more temperatures may include composite temperature values associated with multiple component types of the memory system 110. For example, each composite temperature value may be based on temperatures measured at one or more arrays of non-volatile memory cells (e.g., NAND components), one or more arrays of volatile memory cells (e.g., DRAM components), one or more controllers, or any combination thereof. When determining a composite temperature value, the memory system 110 may calculate an overall temperature of components of the memory system 110 according to an equation using NAND component temperatures, DRAM component temperatures, and controller component temperatures as inputs to the equation. Additionally, or alternatively, the one or more temperatures may include temperature values of components having a similar type (e.g., a NAND temperature, a DRAM temperature). The memory system 110 may use the one or more measured temperatures to calculate one or more temperature stress samples. For example, the memory system 110 may obtain a first temperature measurement (e.g., a composite temperature, a component type temperature) and may calculate a temperature stress sample according to the measured temperature, a sampling interval for the measurement (e.g., a duration between temperature measurements, such as 1 second or another suitable duration), and an acceleration factor associated with the measured temperature. The acceleration factor may account for non-uniform memory system lifetime degradation effects (e.g., performance degradation, reliability degradation) associated with different temperature values. For example, a relatively high temperature may correspond to a higher acceleration factor than a relatively low temperature, such that a greater portion of estimated operable life of the memory system 110 is used if the memory system 110 dwells at the relatively high temperature (e.g., compared to if the memory system 110 dwells for the same duration at the relatively low temperature). In some examples, a lookup table may be stored to the memory system 110 including multiple acceleration factors corresponding to respective temperature values or temperature ranges, and the memory system 110 may retrieve the lookup table to determine an appropriate acceleration factor when calculating a temperature stress sample. The acceleration factors may be determined during manufacture of the memory system 110, such that the memory system 110 may be deployed with the lookup table.

The memory system 110 may calculate temperature stress samples for each temperature measurement and may maintain a sum of the temperature stress samples (e.g., in NAND memory). For example, each temperature stress sample may correspond to a respective portion of the expected life of the memory system 110 that is used during each sampling interval, and the summation of the temperature stress samples may correspond to a cumulative portion of the expected life of the memory system 110 that has been used. In some examples, the memory system 110 may divide the summation of the temperature stress samples by an allowable stress budget associated with the mission profile (e.g., a value corresponding to the predicted lifetime of the memory system 110). Accordingly, the memory system 110 may continuously track a remaining percentage of the predicted life of the memory system 110 while the memory system 110 performs access operations or otherwise executes applications.

In some cases, the memory system 110 may report a lifetime usage indication 195 to the host system 105, which may indicate a remaining portion of the expected lifetime of the memory system 110 at the time when the lifetime usage indication 195 is sent. For example, the memory system 110 may identify a threshold value (e.g., a threshold percentage) that triggers reporting the lifetime usage indication 195 and may report the lifetime usage indication 195 to the host system 105 when a calculated remaining percentage of the predicted life of the memory system 110 satisfies (e.g., goes below) the threshold value. In some cases, the threshold value may be defined during manufacturing (e.g., based on testing operations, a type of system incorporating the memory system 110, or both), may be received from the host system 105, may be selected by a user of the memory system 110, or any combination thereof. Additionally, or alternatively, the host system 105 may transmit one or more requests, and the memory system 110 may report the lifetime usage indication 195 in response to an explicit request from the host system 105. By calculating and reporting the expected remaining lifetime of the memory system 110, the memory system 110 may mitigate a likelihood of unexpected failure and support the host system 105 adjusting operational parameters for the memory system 110 when the memory system 110 is relatively close to failure.

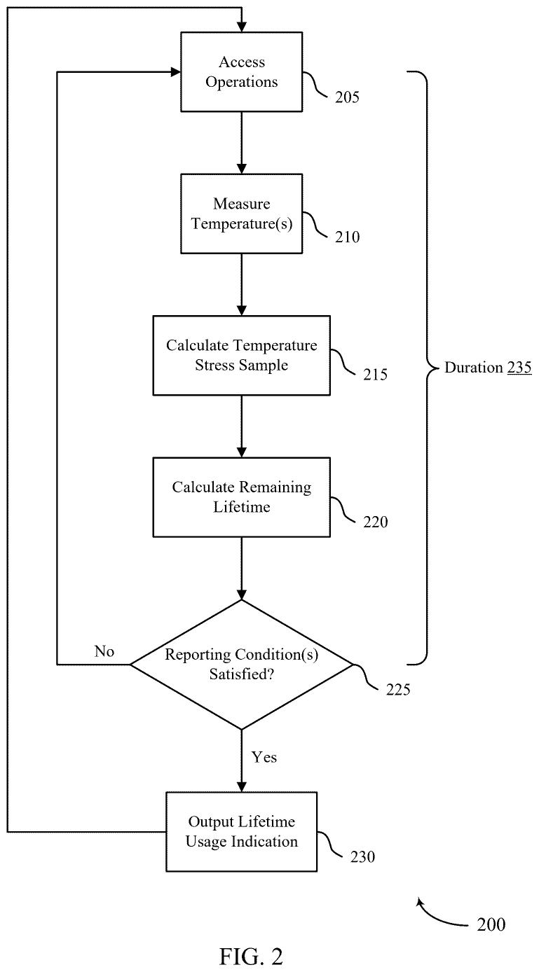

FIG. 2 shows an example of a process 200 that supports remaining lifetime monitoring and indication for memory systems in accordance with various aspects of the present disclosure. The process 200 may implement, or be implemented by, one or more aspects of the system 100. For example, the process 200 shows operations performed by a memory system, which may be an example of a memory system 110 described with reference to FIG. 1. In some examples, the process 200 may support the memory system reporting a lifetime usage indication (e.g., to a host system) that indicates a remaining portion of an expected lifetime of the memory system at a time when the lifetime usage indication is reported. For example, the memory system may determine to output the lifetime usage indication in response to a calculated remaining lifetime satisfying one or more conditions. Alternative examples of the following may be implemented, where some processes are performed in a different order than described or are not performed. In some cases, processes may include additional features not mentioned below, or further processes may be added.

At 205, the memory system may execute one or more access operations. For example, the memory system may receive one or more commands (e.g., issued by a host system) to access data stored in the memory system in accordance with execution of one or more applications. The memory system may execute the one or more access operations to access the data (e.g., write data to the memory system, read data from the memory system, or both) to support the execution of the one or more applications, which may be applications associated with a device or system including the memory system (e.g., a vehicle). In some examples, the memory system may perform the one or more access operations over a duration 235, which may be referred to as a first duration in some examples herein. The first duration may start when the memory system is deployed or otherwise initialized (e.g., turned on) and may represent a duration since initialization. Additionally, or alternatively, the duration 235 may be some other interval of operation of the memory system (e.g., with or without access operations), such as any duration 235 during which the memory system operates and supports execution of one or more applications.

At 210, the memory system may measure one or more temperatures of the memory system. In some cases, the memory system may measure the one or more temperatures at one or more times during the first duration. The memory system may use one or more temperature sensors to measure the one or more temperatures at the one or more times during the first duration. In some examples, the one or more times may be associated with a sampling interval for lifetime reliability calculations at the memory system (e.g., a periodicity for obtaining temperature measurements, such as every 1 second or another suitable periodicity) or some defined temperature measurements intervals. In some cases, the memory system may use the one or more temperature sensors to measure temperatures of one or more components of the memory system.

For example, the memory system may measure a respective temperature of each component of a set of components of the memory system, where the set of components may include one or more arrays of volatile memory cells (e.g., DRAM components), one or more arrays of non-volatile memory cells (e.g., NAND components), one or more controllers, or any combination thereof. In some such examples, the memory system may determine one or more composite temperature values each associated with a respective time of the one or more times. A composite temperature value may correspond to temperature measurements associated with multiple components, such as a maximum temperature of the set of components (e.g., Tcomposite=MAX (TjNAND_valid, Tjcont-Toffset), where TjNAND may represent a junction temperature of a NAND component and Tjcont may represent a junction temperature of a controller), a minimum temperature of the set of components (e.g., Tcomposite=MIN (TjNAND_valid, Tjcont-Toffset)), or an average temperature of the set of components. In some examples, an amount of contribution of a component type temperature value to the composite temperature value may differ between sampling intervals. For example, if a first component type approaches a maximum allowable temperature (e.g., a component temperature is measured relatively near or within a threshold of the maximum allowable temperature for that component type), the composite temperature value may be the temperature value of the first component type (e.g., without other component type temperatures impacting the composite temperature value). Alternatively, if the first component type (or another component type) is not approaching the maximum allowable temperature, the composite temperature may be calculated as an average temperature across each component type, a maximum temperature of another component type, or the like. It should be noted that the memory system may determine a composite temperature according to temperatures associated with any quantity of components, any quantity of component types, and according to any suitable function.

As another example, the memory system may measure the one or more temperatures of one or more components of the memory system that are of a same component type. For example, the memory system may measure, at each respective time of the one or more times, volatile memory components (e.g., DRAM components), non-volatile memory components (e.g., NAND components), or controllers to obtain a temperature value for a component type. In some examples, if the memory system measures multiple components of the same type, the memory system may determine the temperature value based on various functions (e.g., a maximum temperature, a minimum temperature, or an average temperature). The memory system may include other component types not described herein, and may be similarly operable to obtain temperature measurements for the other component types to evaluate a remaining lifetime of the memory system.

At 215, the memory system may calculate a temperature stress sample. The memory system may calculate, at each respective time of the one or more times, a temperature stress sample based on a respective temperature of the one or more temperatures (e.g., measured at 210 for the respective time, which may be a composite temperature or a temperature associated with a single component type), an acceleration factor associated with the respective temperature, and a duration of a respective sampling interval (e.g., a duration between each of the one or more times). For example, the memory system may calculate the temperature stress sample (e.g., FLRGPROD) according to Equation 1 and an acceleration factor according to Equation 2:

$$FRLGPROD ( t ) = A F ( Ttemp\_ACT \_OPt ) * Sample\_interval \_ACT {\_OP}_{𝔱} \qquad ( 1 )$$

$$AF ( Ttemp\_ACT \_OPt ) = ( {exp}^{\frac{E a}{K} ( \frac{1}{{T}_{m i n}} - \frac{1}{{T}_{t}} )} ) \qquad ( 2 )$$

With reference to Equation 1, Temp_ACT_OPt may represent an active temperature at a respective sampling time, AF is a calculation or lookup that is a function of the active temperature sample at the respective sampling time, and represents an acceleration factor, and Sample_interval_ACT_OPt may represent a duration of the sampling interval. The acceleration factor may account for non-uniform or non-linear effects of temperature on lifetime degradation at the memory system (e.g., performance degradation, reliability degradation). For example, increasing temperatures may be associated with increasing acceleration factor values, where the acceleration factor values may increase exponentially. Accordingly, a first temperature stress value calculated for a relatively high temperature value may be significantly greater than a second temperature stress value calculated for a relatively low temperature (e.g., accounting for exponentially higher performance degradation at the relatively high temperature).

With reference to Equation 2, the memory system may determine (e.g., calculate) an acceleration factor according to an activation energy Ea, a minimum temperature Tₘᵢₙ, a test temperature Tₜ, a constant (e.g., a Boltzmann constant) K, and a central temperature range for calculation of the acceleration factor T_{comp*} (which may be a value chosen for the calculation of the acceleration factor, such as 100). In some cases, Equation 2 may be an example of the Arrhenius equation. In some examples, the acceleration factor may be device-specific. That is, the acceleration factor for a given memory system may be determined during manufacture of the memory system based on various physical properties of the memory system. In some examples, the memory system may store a lookup table including multiple acceleration factors mapped to multiple candidate temperatures. For example, the lookup table may be stored to the memory system during manufacture of the memory system, received from the host system during operations, or both. The memory system may retrieve the lookup table and may determine an appropriate acceleration factor based on the respective temperature measurement for calculating a temperature stress sample.

At 220, the memory system may calculate a remaining portion of the expected lifetime of the memory system. In some cases, the memory system may calculate, at each respective time of the one or more times, the remaining portion of the expected lifetime based on a summation of previously obtained temperature stress values and an allowable stress budget of the memory system. For example, after calculating a temperature stress sample for a sampling interval (e.g., at 215), the memory system may sum the temperature stress sample with previous temperature stress samples associated with previous sampling intervals within the first duration (e.g., since initialization of the memory system), such that the memory system may maintain a running total of the temperature stress samples after each sampling interval (e.g., corresponding to a total amount of expected life used after each sampling interval). The memory system may divide the summed temperature stress samples by the allowable stress budget, which may be based on a mission profile for the memory system. As described herein, the mission profile may include a predicted lifetime of the memory system (e.g., quantified as the allowable stress budget) based on one or more test procedures performed during manufacture of the memory system. For example, the predicted lifetime of the memory system may be based on estimated times (e.g., dwell durations) the memory system is expected to operate in for various temperature values during an operable life of the memory system. That is, the mission profile may be represented as a curve between weighted temperatures (e.g., a product of a temperature, a corresponding acceleration factor, and an estimated dwell duration) and candidate temperature values, such that the allowable stress budget may correspond to an area under the curve. The memory system may calculate the remaining portion of the expected lifetime (e.g., a field reliability life gauge (FRLG)) of the memory system according to Equation 3:

$$FRLG = 1 - \frac{[ {\sum }_{t = 0}^{p resent} ( FRLGPROD ( t ) ) ]}{FRLGBudget} \qquad ( 3 )$$

With reference to Equation 3,

$${\sum }_{t = 0}^{p resent} ( F RLGPROD ( t ) )$$

may represent the summation of temperature stress samples since a first time at which the first duration starts up to a current temperature stress sample and FRLGBudget may correspond to the allowable stress budget. Accordingly, as temperature stress samples are summed, the total temperature stress may become increasingly closer to the allowable stress budget. By subtracting the total temperature stress over the allowable stress budget from 1, the memory system may determine a percentage of remaining lifetime of the memory system after calculating each temperature stress sample.

At 225, the memory system may determine whether one or more conditions for reporting a lifetime usage indication are satisfied. The one or more conditions may include a comparison between the remaining portion of the expected lifetime and a threshold value, a request for the lifetime usage indication, or both.

As an example, the memory system may determine whether the remaining portion of the expected lifetime of the memory system (e.g., calculated at 220) satisfies a threshold value. In some cases, the threshold value may be based on one or more second test procedures performed during manufacture of the memory system (e.g., a default threshold, which may be based on a type of product (e.g., a stock keeping unit (SKU)) or implementation associated with the memory system), may be based on an input received at the memory system (e.g., a user configured threshold), or both. In such examples, the memory system may compare the calculated remaining portion of the expected lifetime with the threshold value after each sampling interval (e.g., each time of the one or more times) to determine whether to output the lifetime usage indication. In some cases, the memory system may determine that the remaining portion of the expected lifetime satisfies (e.g., goes below) the threshold value after a first duration. For example, if the memory system determines, after calculating a temperature stress sample, that the remaining portion of the expected lifetime does not satisfy the threshold value, the memory system may return to step 205 of the process 200. Alternatively, if memory system determines that the remaining portion of the expected lifetime satisfies the threshold value, the memory system may move to step 230 of the process 200. As described herein, the first duration may correspond to a duration 235 that occurs between initial operation of the memory system and a first reporting of the lifetime usage indication (e.g., once the remaining portion of the expected lifetime satisfies the threshold value). That is, a duration 235 may correspond to the memory system cycling through steps 205 and 225 of the process 200 until a lifetime usage indication is triggered to be reported.

As another example, the memory system may determine whether to report the lifetime usage indication (e.g., whether to proceed to step 230 of the process 200 or return to step 205 of the process 200) based on whether a request for the lifetime usage indication is received. For example, a user of the memory system (or a device including the memory system) may input a request for the lifetime usage indication, and the memory system may receive a command (e.g., from a host system) to output the lifetime usage indication including a remaining portion of the expected lifetime at the time when the lifetime usage indication was requested. In some examples, if the memory system does not identify a request for the lifetime usage indication and the remaining portion of the expected lifetime does not satisfy the threshold value, the memory system may return to step 205 of the process 200 and continue calculating the remaining portion of the expected lifetime after each sampling interval (e.g., cycling through steps 205 to 225 until the threshold value is satisfied or a request for the lifetime usage indication is received).

At 230, the memory system may output the lifetime usage indication. For example, the memory system may output the lifetime usage indication in response to the one or more conditions for reporting the lifetime usage indication being satisfied. The lifetime usage indication may indicate a remaining portion of the expected lifetime of the memory system at a time the lifetime usage indication is reported. In some examples, the memory system may output multiple lifetime usage indications at different times. For example, the memory system may output, after a first duration, a first instance of the lifetime usage indication that indicates a first remaining portion of the expected lifetime (e.g., based on the first remaining portion satisfying the threshold value, a request from a user, or both) and may output, after a second duration, a second instance of the lifetime usage indication that indicates a second remaining portion of the expected lifetime (e.g., based on the second remaining portion satisfying the threshold value, satisfying another threshold value, a request from the user, or any combination thereof). Therefore, by reporting the lifetime usage indication, the memory system may inform a host system and a user of the memory system of the remaining portion of the expected lifetime of the memory system, which may support the host system and user adjusting operational parameters or durations associated with the memory system. For example, based on identifying that the memory system has exhausted a significant portion of the expected remaining lifetime, the host system may reduce a frequency of access operations at the memory system, a user may refrain from using the memory system (or a vehicle including the memory system) at relatively high temperatures, or both, among other examples.

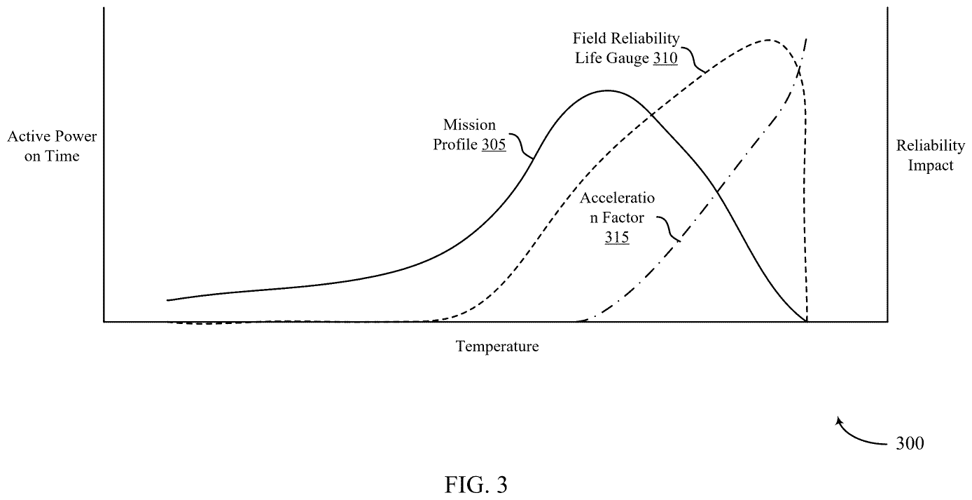

FIG. 3 shows an example reliability graph 300 that supports remaining lifetime monitoring and indication for memory systems in accordance with various aspects of the present disclosure. The reliability graph 300 may implement, or be implemented by, one or more aspects of the system 100 and the process 200. For example, the reliability graph 300 includes a first curve representing a mission profile 305, a second curve representing an FRLG 310, and a third curve representing an acceleration factor 315, which may be examples of corresponding aspects described with reference to FIGS. 1 and 2. In some examples, the reliability graph 300 may be stored at or otherwise utilized by a memory system, which may be an example of a memory system 110 described herein. Additionally, or alternatively, the reliability graph 300 may represent an abstracted example of calculations and general metadata and tracking information obtained and used by the memory system during its lifetime. The memory system may utilize the reliability graph to determine whether to transmit a lifetime usage indication (e.g., to a host system) that indicates a remaining portion of an expected lifetime of the memory system at a time when the lifetime usage indication is reported.

The reliability graph 300 may show relationships between temperature values and active power on times as well as a reliability impact. For example, temperature values may increase across the x-axis of the reliability graph 300, active power on times may increase across the y-axis of the reliability graph 300, and the reliability impact may increase across the y-axis of the reliability graph. The reliability impact may be calculated as a result of temperature, active power on time, and an acceleration factor (e.g., reliability impact may be a product of the acceleration factor for a temperature value and the active power time).

In some examples, the first curve representing the mission profile 305 may show an expected or predicted lifetime of the memory system (e.g., according to testing operations for the memory system during manufacture of the memory system, according to expected operations of the memory system during the lifetime of the memory system). For example, an area under the first curve of the mission profile 305 may indicate a value indicative of the expected lifetime of the memory system. The memory system may utilize the value of the mission profile 305 to calculate an expected remaining portion of the lifetime of the memory system (e.g., the value may be used as FRLGBudget in Equation 3 described with reference to FIG. 2). The second curve representing the FRLG 310 may indicate actual usage of the memory system during operations of the memory system. For example, the area under the second curve may be indicative of a value of usage of the memory system based on active power on times at various temperature ranges during the operations of the memory system. The memory system may periodically use the value of the area under the second curve for calculating the FLRG (e.g., FRLGPROD(t) in Equation 3 described with reference to FIG. 2) and determining whether to report the lifetime usage indication. The third curve representing the acceleration factor may show a relationship between a value of the acceleration factor and different temperatures. For example, the value of the acceleration factor may increase (e.g., non-linearly, exponentially) as temperature increases, thereby accounting for increased reliability impact at higher temperature values.

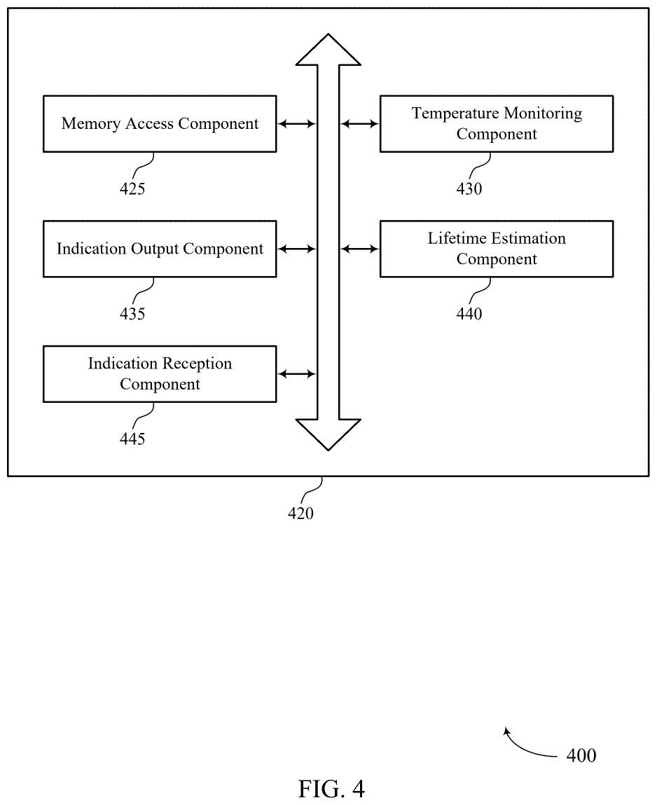

FIG. 4 shows a block diagram 400 of a memory system 420 that supports remaining lifetime monitoring and indication for memory systems in accordance with examples as disclosed herein. The memory system 420 may be an example of aspects of a memory system as described with reference to FIGS. 1 through 3. The memory system 420, or various components thereof, may be an example of means for performing various aspects of remaining lifetime monitoring and indication for memory systems as described herein. For example, the memory system 420 may include a memory access component 425, a temperature monitoring component 430, an indication output component 435, a lifetime estimation component 440, an indication reception component 445, or any combination thereof. Each of these components, or components of subcomponents thereof (e.g., one or more processors, one or more memories), may communicate, directly or indirectly, with one another (e.g., via one or more buses).

The memory access component 425 may be configured as or otherwise support a means for operating, during a first duration the memory system in accordance with execution of one or more applications. The temperature monitoring component 430 may be configured as or otherwise support a means for measuring one or more temperatures of the memory system at one or more times during the first duration. The indication output component 435 may be configured as or otherwise support a means for outputting a lifetime usage indication that indicates a remaining portion of an expected lifetime of the memory system that remains after the first duration, where the remaining portion is based at least in part on the one or more temperatures of the memory system and a mission profile for the memory system, where the mission profile includes a predicted temperature profile for the memory system based at least in part on one or more test procedures.

In some examples, to support measuring the one or more temperatures, the temperature monitoring component 430 may be configured as or otherwise support a means for measuring, using one or more temperature sensors and at the one or more times during the first duration, a respective temperature of each component of a set of components of the memory system.

In some examples, the set of components of the memory system include one or more arrays of volatile memory cells, one or more arrays of non-volatile memory cells, one or more controllers, or any combination thereof.

In some examples, the remaining portion of the expected lifetime of the memory system is based at least in part on one or more composite temperature values each associated with a respective time of the one or more times; and each composite temperature value of the one or more composite temperature values corresponds to a maximum temperature of the one or more temperatures measured at the set of components at the respective time, a minimum temperature of the one or more temperatures measured at the set of components at the respective time, or an average temperature of the one or more temperatures measured at the set of components at the respective time.

In some examples, to support measuring the one or more temperatures, the temperature monitoring component 430 may be configured as or otherwise support a means for measuring, using one or more temperature sensors and at the one or more times during the first duration, the one or more temperatures of one or more components of the memory system that are of a same component type, where the lifetime usage indication is associated with the same component type, and where the memory system includes one or more other components having one or more other component types.

In some examples, the lifetime estimation component 440 may be configured as or otherwise support a means for calculating the remaining portion of the expected lifetime of the memory system that remains after the first duration based at least in part on a summation of one or more temperature stress samples associated with the memory system at the one or more times during the first duration and based at least in part on an allowable stress budget associated with the mission profile for the memory system.

In some examples, the one or more times during the first duration correspond to one or more sampling intervals for lifetime reliability calculations; and each temperature stress sample of the one or more temperature stress samples is associated with a respective time of the one or more times during the first duration and is based at least in part on a respective temperature, of the one or more temperatures, measured at the respective time, an acceleration factor associated with the respective temperature, and a duration of a respective sampling interval, of the one or more sampling intervals, that is associated with the respective time.

In some examples, the memory access component 425 may be configured as or otherwise support a means for retrieving a lookup table including a plurality of acceleration factors mapped to a plurality of candidate temperatures. In some examples, the lifetime estimation component 440 may be configured as or otherwise support a means for determining the acceleration factor associated with the respective temperature based at least in part on the lookup table.

In some examples, the temperature monitoring component 430 may be configured as or otherwise support a means for measuring one or more second temperatures of the memory system at one or more times during a second duration following the first duration. In some examples, the indication output component 435 may be configured as or otherwise support a means for outputting a second instance of the lifetime usage indication that indicates a second remaining portion of the expected lifetime of the memory system that remains after the second duration, where the second remaining portion is based at least in part on the remaining portion after the first duration, the one or more second temperatures, and the mission profile.

In some examples, the mission profile for the memory system is based at least in part on the one or more test procedures performed during manufacture of the memory system.

In some examples, the indication reception component 445 may be configured as or otherwise support a means for receiving a request for the lifetime usage indication, where outputting the lifetime usage indication is in response to the request.

In some examples, the lifetime estimation component 440 may be configured as or otherwise support a means for determining that the remaining portion of the expected lifetime of the memory system that remains after the first duration satisfies a threshold value, where outputting the lifetime usage indication is based at least in part on the remaining portion satisfying the threshold value.

In some examples, the threshold value is based at least in part on one or more second test procedures performed during manufacture of the memory system, or is based at least in part on input received at the memory system, or both.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

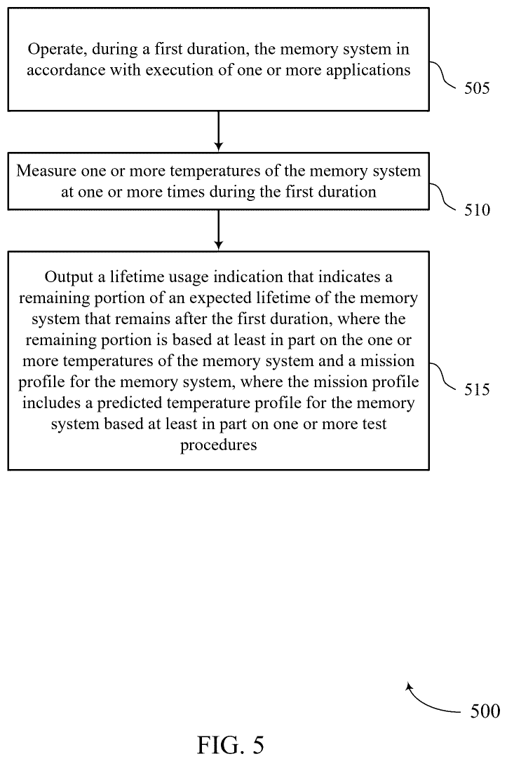

FIG. 5 shows a flowchart illustrating a method 500 that supports remaining lifetime monitoring and indication for memory systems in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include operating, during a first duration the memory system in accordance with execution of one or more applications. In some examples, aspects of the operations of 505 may be performed by a memory access component 425 as described with reference to FIG. 4.

At 510, the method may include measuring one or more temperatures of the memory system at one or more times during the first duration. In some examples, aspects of the operations of 510 may be performed by a temperature monitoring component 430 as described with reference to FIG. 4.

At 515, the method may include outputting a lifetime usage indication that indicates a remaining portion of an expected lifetime of the memory system that remains after the first duration, where the remaining portion is based at least in part on the one or more temperatures of the memory system and a mission profile for the memory system, where the mission profile includes a predicted temperature profile for the memory system based at least in part on one or more test procedures. In some examples, aspects of the operations of 515 may be performed by an indication output component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating, during a first duration, the memory system in accordance with execution of one or more applications; measuring one or more temperatures of the memory system at one or more times during the first duration; and outputting a lifetime usage indication that indicates a remaining portion of an expected lifetime of the memory system that remains after the first duration, where the remaining portion is based at least in part on the one or more temperatures of the memory system and a mission profile for the memory system, where the mission profile includes a predicted temperature profile for the memory system based at least in part on one or more test procedures.

Aspect 2: The method, apparatus, or non-transitory computer-readable medium of aspect 1, where measuring the one or more temperatures includes operations, features, circuitry, logic, means, or instructions, or any combination thereof for measuring, using one or more temperature sensors and at the one or more times during the first duration, a respective temperature of each component of a set of components of the memory system.

Aspect 3: The method, apparatus, or non-transitory computer-readable medium of aspect 2, where the set of components of the memory system include one or more arrays of volatile memory cells, one or more arrays of non-volatile memory cells, one or more controllers, or any combination thereof.

Aspect 4: The method, apparatus, or non-transitory computer-readable medium of any of aspects 2 through 3, where the remaining portion of the expected lifetime of the memory system is based at least in part on one or more composite temperature values each associated with a respective time of the one or more times; and each composite temperature value of the one or more composite temperature values corresponds to a maximum temperature of the one or more temperatures measured at the set of components at the respective time, a minimum temperature of the one or more temperatures measured at the set of components at the respective time, or an average temperature of the one or more temperatures measured at the set of components at the respective time.

Aspect 5: The method, apparatus, or non-transitory computer-readable medium of any of aspects 1 through 4, where measuring the one or more temperatures includes operations, features, circuitry, logic, means, or instructions, or any combination thereof for measuring, using one or more temperature sensors and at the one or more times during the first duration, the one or more temperatures of one or more components of the memory system that are of a same component type, where the lifetime usage indication is associated with the same component type, and where the memory system includes one or more other components having one or more other component types.

Aspect 6: The method, apparatus, or non-transitory computer-readable medium of any of aspects 1 through 5, further including operations, features, circuitry, logic, means, or instructions, or any combination thereof for calculating the remaining portion of the expected lifetime of the memory system that remains after the first duration based at least in part on a summation of one or more temperature stress samples associated with the memory system at the one or more times during the first duration and based at least in part on an allowable stress budget associated with the mission profile for the memory system.

Aspect 7: The method, apparatus, or non-transitory computer-readable medium of aspect 6, where the one or more times during the first duration correspond to one or more sampling intervals for lifetime reliability calculations; and each temperature stress sample of the one or more temperature stress samples is associated with a respective time of the one or more times during the first duration and is based at least in part on a respective temperature, of the one or more temperatures, measured at the respective time, an acceleration factor associated with the respective temperature, and a duration of a respective sampling interval, of the one or more sampling intervals, that is associated with the respective time.

Aspect 8: The method, apparatus, or non-transitory computer-readable medium of aspect 7, further including operations, features, circuitry, logic, means, or instructions, or any combination thereof for retrieving a lookup table including a plurality of acceleration factors mapped to a plurality of candidate temperatures and determining the acceleration factor associated with the respective temperature based at least in part on the lookup table.

Aspect 9: The method, apparatus, or non-transitory computer-readable medium of any of aspects 1 through 8, further including operations, features, circuitry, logic, means, or instructions, or any combination thereof for measuring one or more second temperatures of the memory system at one or more times during a second duration following the first duration and outputting a second instance of the lifetime usage indication that indicates a second remaining portion of the expected lifetime of the memory system that remains after the second duration, where the second remaining portion is based at least in part on the remaining portion after the first duration, the one or more second temperatures, and the mission profile.

Aspect 10: The method, apparatus, or non-transitory computer-readable medium of any of aspects 1 through 9, where the mission profile for the memory system is based at least in part on the one or more test procedures performed during manufacture of the memory system.

Aspect 11: The method, apparatus, or non-transitory computer-readable medium of any of aspects 1 through 10, further including operations, features, circuitry, logic, means, or instructions, or any combination thereof for receiving a request for the lifetime usage indication, where outputting the lifetime usage indication is in response to the request.

Aspect 12: The method, apparatus, or non-transitory computer-readable medium of any of aspects 1 through 11, further including operations, features, circuitry, logic, means, or instructions, or any combination thereof for determining that the remaining portion of the expected lifetime of the memory system that remains after the first duration satisfies a threshold value, where outputting the lifetime usage indication is based at least in part on the remaining portion satisfying the threshold value.

Aspect 13: The method, apparatus, or non-transitory computer-readable medium of aspect 12, where the threshold value is based at least in part on one or more second test procedures performed during manufacture of the memory system, or is based at least in part on input received at the memory system, or both.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
operate, during a first duration, the memory system in accordance with execution of one or more applications;
measure one or more temperatures of the memory system at one or more times during the first duration; and
output a lifetime usage indication that indicates a remaining portion of an expected lifetime of the memory system that remains after the first duration, wherein the remaining portion is based at least in part on the one or more temperatures of the memory system and a mission profile for the memory system, wherein the mission profile comprises a predicted temperature profile for the memory system.

2. The memory system of claim 1, wherein the processing circuitry is further configured to cause the memory system to:
calculate the remaining portion of the expected lifetime of the memory system that remains after the first duration based at least in part on a summation of one or more temperature stress samples associated with the memory system at the one or more times during the first duration and based at least in part on an allowable stress budget associated with the mission profile for the memory system.

3. The memory system of claim 2, wherein:
the one or more times during the first duration correspond to one or more sampling intervals for lifetime reliability calculations; and
each temperature stress sample of the one or more temperature stress samples is associated with a respective time of the one or more times during the first duration and is based at least in part on a respective temperature, of the one or more temperatures, measured at the respective time, an acceleration factor associated with the respective temperature, and a duration of a respective sampling interval, of the one or more sampling intervals, that is associated with the respective time.

4. The memory system of claim 3, wherein the processing circuitry is further configured to cause the memory system to:
retrieve a lookup table comprising a plurality of acceleration factors mapped to a plurality of candidate temperatures; and
determine the acceleration factor associated with the respective temperature based at least in part on the lookup table, based at least in part on an equation, or both.

5. The memory system of claim 1, wherein measuring the one or more temperatures comprises the processing circuitry configured to cause the memory system to:
measure, using one or more temperature sensors and at the one or more times during the first duration, a respective temperature of each component of a set of components of the memory system.

6. The memory system of claim 5, wherein the set of components of the memory system comprise one or more arrays of volatile memory cells, one or more arrays of non-volatile memory cells, one or more controllers, or any combination thereof.

7. The memory system of claim 5, wherein:
the remaining portion of the expected lifetime of the memory system is based at least in part on one or more composite temperature values each associated with a respective time of the one or more times; and
each composite temperature value of the one or more composite temperature values corresponds to a maximum temperature of the one or more temperatures measured at the set of components at the respective time, a minimum temperature of the one or more temperatures measured at the set of components at the respective time, or an average temperature of the one or more temperatures measured at the set of components at the respective time.

8. The memory system of claim 1, wherein measuring the one or more temperatures comprises the processing circuitry configured to cause the memory system to:
measure, using one or more temperature sensors and at the one or more times during the first duration, the one or more temperatures of one or more components of the memory system that are of a same component type, wherein the lifetime usage indication is associated with the same component type, and wherein the memory system comprises one or more other components having one or more other component types.

9. The memory system of claim 1, wherein the processing circuitry is further configured to cause the memory system to:
measure one or more second temperatures of the memory system at one or more times during a second duration following the first duration; and
output a second instance of the lifetime usage indication that indicates a second remaining portion of the expected lifetime of the memory system that remains after the second duration, wherein the second remaining portion is based at least in part on the remaining portion after the first duration, the one or more second temperatures, and the mission profile.

10. The memory system of claim 1, wherein the mission profile for the memory system is based at least in part on one or more test procedures performed during manufacture of the memory system.

11. The memory system of claim 1, wherein the processing circuitry is further configured to cause the memory system to:
receive a request for the lifetime usage indication, wherein outputting the lifetime usage indication is in response to the request.

12. The memory system of claim 1, wherein the processing circuitry is further configured to cause the memory system to:
determine that the remaining portion of the expected lifetime of the memory system that remains after the first duration satisfies a threshold value, wherein outputting the lifetime usage indication is based at least in part on the remaining portion satisfying the threshold value.

13. The memory system of claim 12, wherein the threshold value is based at least in part on one or more second test procedures performed during manufacture of the memory system, or is based at least in part on input received at the memory system, or both.

14. A method by a memory system, comprising:
executing, during a first duration, one or more access operations to access data stored in the memory system, wherein the one or more access operations are in accordance with execution of one or more applications;
measuring one or more temperatures of the memory system at one or more times during the first duration; and
outputting a lifetime usage indication that indicates a remaining portion of an expected lifetime of the memory system that remains after the first duration, wherein the remaining portion is based at least in part on the one or more temperatures of the memory system and a mission profile for the memory system, wherein the mission profile comprises a predicted temperature profile for the memory system based at least in part on one or more test procedures.

15. The method of claim 14, further comprising:
calculating the remaining portion of the expected lifetime of the memory system that remains after the first duration based at least in part on a summation of one or more temperature stress samples associated with the memory system at the one or more times during the first duration and based at least in part on an allowable stress budget associated with the mission profile for the memory system.

16. The method of claim 15, wherein:
the one or more times during the first duration correspond to one or more sampling intervals for lifetime reliability calculations; and
each temperature stress sample of the one or more temperature stress samples is associated with a respective time of the one or more times during the first duration and is based at least in part on a respective temperature, of the one or more temperatures, measured at the respective time, an acceleration factor associated with the respective temperature, and a duration of a respective sampling interval, of the one or more sampling intervals, that is associated with the respective time.

17. The method of claim 16, further comprising:
retrieving a lookup table comprising a plurality of acceleration factors mapped to a plurality of candidate temperatures; and
determining the acceleration factor associated with the respective temperature based at least in part on the lookup table.

18. The method of claim 14, wherein measuring the one or more temperatures comprises:
measuring, using one or more temperature sensors and at the one or more times during the first duration, a respective temperature of each component of a set of components of the memory system.

19. The method of claim 18, wherein the set of components of the memory system comprise one or more arrays of volatile memory cells, one or more arrays of non-volatile memory cells, one or more controllers, or any combination thereof.

20. The method of claim 18, wherein:
the remaining portion of the expected lifetime of the memory system is based at least in part on one or more composite temperature values each associated with a respective time of the one or more times; and
each composite temperature value of the one or more composite temperature values corresponds to a maximum temperature of the one or more temperatures measured at the set of components at the respective time, a minimum temperature of the one or more temperatures measured at the set of components at the respective time, or an average temperature of the one or more temperatures measured at the set of components at the respective time.

21. The method of claim 14, wherein measuring the one or more temperatures comprises:
measuring, using one or more temperature sensors and at the one or more times during the first duration, the one or more temperatures of one or more components of the memory system that are of a same component type, wherein the lifetime usage indication is associated with the same component type, and wherein the memory system comprises one or more other components having one or more other component types.

22. The method of claim 14, further comprising:
measuring one or more second temperatures of the memory system at one or more times during a second duration following the first duration; and
outputting a second instance of the lifetime usage indication that indicates a second remaining portion of the expected lifetime of the memory system that remains after the second duration, wherein the second remaining portion is based at least in part on the remaining portion after the first duration, the one or more second temperatures, and the mission profile.

23. The method of claim 14, wherein the mission profile for the memory system is based at least in part on the one or more test procedures performed during manufacture of the memory system.

24. The method of claim 14, further comprising:
receiving a request for the lifetime usage indication, wherein outputting the lifetime usage indication is in response to the request.

25. A non-transitory computer-readable medium storing code, the code comprising instructions executable by one or more processors to:
execute, during a first duration, one or more access operations to access data stored in a memory system, wherein the one or more access operations are in accordance with execution of one or more applications;
measure one or more temperatures of the memory system at one or more times during the first duration; and
output a lifetime usage indication that indicates a remaining portion of an expected lifetime of the memory system that remains after the first duration, wherein the remaining portion is based at least in part on the one or more temperatures of the memory system and a mission profile for the memory system, wherein the mission profile comprises a predicted temperature profile for the memory system based at least in part on one or more test procedures.
